(19) United States
(12) Patent Application Publication
(10) Pub. No.: US 2010/0101107 A1
(43) Pub. Date: Apr. 29, 2010

(54) METHOD AND SYSTEM FOR DRYING FUELS IN THE FORM OF DUST, PARTICULARLY TO BE FED TO A GASIFICATION PROCESS

(75) Inventors: Johannes Kowoll, Bochum (DE); Eberhard Kuske, Soest (DE)

Correspondence Address: COLLARD & ROE, P.C., 1077 NORTHERN BOULEVARD, ROSLYN, NY, 11576, US

(73) Assignee: Uhde GmbH, Dortmund (DE)

(21) Appl. No.: 12/449,287

(22) PCT Filed: Dec. 14, 2007
(86) PCT No.: PCT/EP2007/011008

§ 371 Date: Jul. 31, 2009

(30) Foreign Application Priority Data
Feb. 6, 2007 (DE) 10 2007 005 782.4

(51) Int. Cl. F26B 1/00; F26B 17/10; F26B 21/04

(52) U.S. Cl. 34/368; 34/371; 34/372; 34/460; 34/472; 34/576; 34/582; 34/591

(57) ABSTRACT

According to a method for drying fuels in the form of dust, particularly to be fed to a gasification process, such as coal, petroleum coke, biological waste, or the like, wherein the fuel (1) is crushed in a mill (2) and fed to a filter/separator (3) by means of a propellant and drying gas, and at least part of the propellant/drying gas in the circuit is returned to the mill (2) after heating, the known disadvantages are not only to be avoided, but particularly a cost-effective milling and drying method and a corresponding system are to be provided, having low emissions and a low inert gas requirement. This is achieved according to the method in that part of the propellant/drying gas flow is cooled down and dehumidified in a spray tower (6), or the like, wherein part of the dried gas exiting the spray tower is fed to the environment and/or a firing process, and the other part is returned to the propellant/drying gas flow.

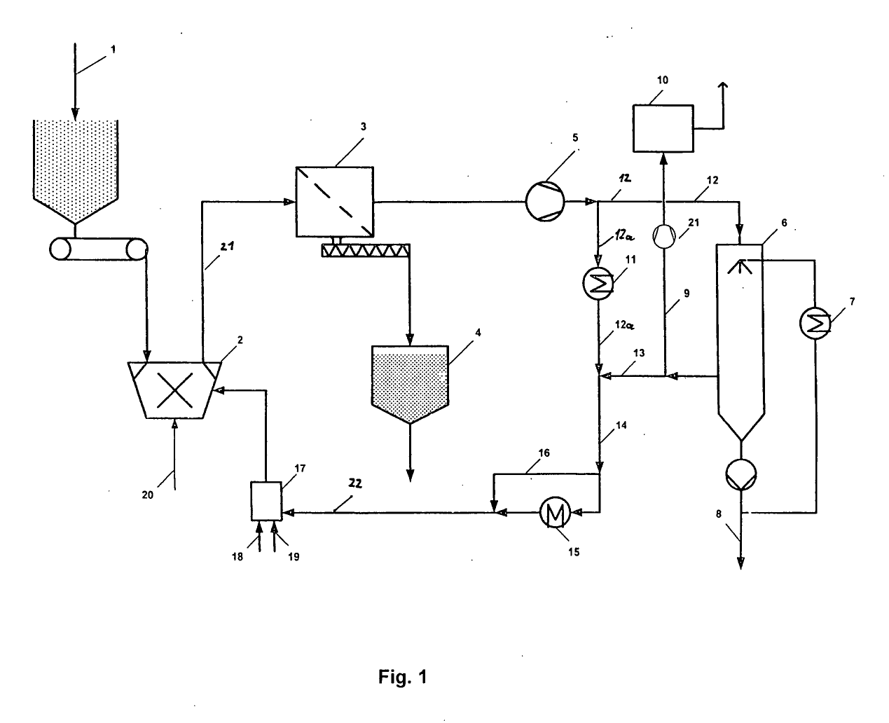

This invention is directed at a method and a system for drying fuels in the form of dust, especially fuels to be fed to a gasification process, such as coal, petroleum coke, biological wastes, or the like, of the type indicated in the preamble of the first method claim and the first system claim, respectively.

Such methods and systems are known in various embodiments and configurations. Thus, for example, U.S. Pat. No. 4,750,434 describes heating and drying of dust particles fed to a mill. EP-0 203 059-A, DE-37 24 960-A, and DE-39 43 366-A, to mention only a few examples, describe how lignite is crushed and dried.

It is known, in this connection, that the dried dust is separated from the waste gases by a dust filter, e.g. a cloth filter. In this connection, a portion of the waste gas is released into the atmosphere, whereby it is also known to mix a portion of the hot waste gases with air and inert gases and to return it to the grinding system. The amount of fresh gases to be fed in is usually chosen so that the proportion of oxygen, depending on the type of fuel, is below 6 to 10 vol. -%, and the dew point of the gas flowing out of the mill is below 65° C. The resulting amount of inert gas, for example, is 4000 m³ and that of the released moist waste gas is about 10000 m³ per unit ton of the vaporized water.

The temperature of the gas flowing into the mill is in the range of 150 to 450° C., and a portion of the ground particles reaches almost the gas temperature. Coal degasification begins even below 200° C., whereby CH₄, C₂H₆, and CO are given off first. During the grinding and heating of petroleum coke, and of roasted biological fuels, a number of toxins can be formed, for example cyclic hydrocarbons, so that emission limits for hydrocarbons and for some individual substances may be exceeded with these alternative fuels. Removal of such toxins from very large streams of waste gas, for example 200,000 m³/h for 100 tons/h of coal containing 20% moisture, would be costly and thus also inefficient. It is also a disadvantage here that for the drying of lignite, for example, which often contains more than 50% moisture, with hot gases at gas temperatures between 350 and 1000° C., volatile constituents are formed that can no longer be released into the atmosphere.

In the literature references mentioned above, there are sometimes instructions to heat crushed coal in a fluidized bed, with a heat exchanger, whereby a portion of the gas leaving the fluidized bed consists of almost pure steam and is compressed to 3 to 5 bar, in order to raise the temperature at which the gas can then be fed back into the heat exchanger immersed in the fluidized bed. This steam condenses there and releases its heat of condensation to the fluidized bed, whereby the temperature of the heat exchanger surfaces is below 150° C., so that no degasification products are released. However, the coal has to be ground again before being transported to the entrained flow gasifier, so that a total of two mills is required, with complicated drying, so that such lignite grinding and drying systems are clearly more expensive than the corresponding systems for bituminous coal.

Therefore, the present invention is intended not only to avoid the disadvantages described above, but its task in particular consists in proposing a cost-advantageous grinding and drying method and a corresponding system, with low emissions and low inert gas demand.

This problem is solved, according to the invention, by a method of the type designated initially, by providing that a portion of the transport/drying gas stream is cooled and dried in a spray tower or the like, whereby a portion of the dried gas leaving the spray tower is passed back into the surroundings and/or to a furnace, and the other portion is passed back into the transport/drying gas stream.

It can be seen that with the procedure according to the invention, a portion of the recycled gas is cooled in the spray tower, in order to lower the moisture content and thus to enable the circulating gas to give up the coal moisture once again. In this connection, some of the gas leaving the spray tower can be cleaned, for example by way of an adsorbent, and released to the surroundings, or it can be fed to a furnace and/or a catalytic reactor, in order to combust the hydrocarbons originating from the fuel and other degasification products, and to remove the nitrogen oxides formed during the combustion.

Embodiments of the method according to the invention are found in the dependent claims relating to the method, and in the system claims.

To overcome pressure losses of the gas purification/combustion upon leaving the system, for example, the circulation pressure can be raised, or alternatively, as the invention provides for in an embodiment, an appropriate blower can be used to raise the pressure. According to the invention, complete removal of the toxins from a small waste gas stream is possible at low effort and cost. A spent solid adsorbent, for example activated charcoal, can also be mixed into the fuel and gasified, at no cost. All toxins are completely destroyed at the high temperatures of the entrained flow gasifier.

In another embodiment, the portion of recycled gas can be heated, for example in a first heat exchanger, whereby the temperature can be selected so that the temperature of the gas stream in the system circulation is above the dew point after mixing with the substream of gas from the spray tower, so that the droplets and wet dust particles entrained in the spray tower are vaporized or dried before entering a subsequent heat exchanger.

In the case of a possible failure of the coal feed, the hot gas is barely cooled in the mill. This would lead to the destruction of the filter bags in a very short time. This problem can be dealt with according to the invention by providing that the additional heat exchanger can be bypassed. Use is advantageously made here of the fact that the diversion of such gas streams occurs distinctly more quickly than cooling in a heat exchanger, so that the cloth filters are effectively protected against high temperatures.

The circulated transport/drying gas can be further increased, according to the invention, by burning a fuel, since in the present case, clearly higher prevailing temperatures can be reached than with conventional grinding systems, because no degasification products are released into the atmosphere. The necessary gas circulation is reduced by this temperature increase, and with this the investment costs for the system elements of the gas circulation are lowered.

It is advantageous, according to the invention, to use hydrogen-rich fuel gas and oxygen as the combustion medium, which in turn leads to a reduction of the waste gas stream.

In another embodiment according to the invention, it can be provided that the oxygen content in circulation is lowered with inert gas before the grinding system is started up, with the burner turned off, whereby the term inert gas here comprises N₂, noble gases, and/or CO₂, but not steam. The inert gas demand according to the invention is extremely low, even if oxygen-free gas is aimed at during the grinding and drying of a highly reactive lignite, which can already ignite at temperatures above 40° C.

Other characteristics, details, and advantages of the invention are evident from the following description and from the drawing. The drawing, in its single figure, shows a system schematic according to the invention.

In the system shown in the figure, a fuel, for example lignite, is fed to the system according to the arrow 1, and is delivered to the mill 2 by means of an appropriate conveyor. The mill 2 simultaneously serves to crush, dry, and sift, whereby the fine dust that is formed, <0.5 mm, is discharged pneumatically at 60 to 120° C., and fed to a filter 3 by way of the line 21, which filter separates the solids and delivers them to a container 4, so that the crushed and dried fuel can be delivered to further processes.

A blower 5 is provided to transport the transport/drying gas in circulation, with which blower the purified gas is moved along, whereby a substream is fed, by way of a line labeled 12, to a spray tower 6 for cooling, and another substream is passed along, by way of a heat exchanger 11 for heating, and by way of the line 12a. In this connection, at least 15% of the amounts leaving the blower 5 are passed into the heat exchanger 11.

The proportion of gas to the heat exchanger 11 depends primarily on the gas temperature ahead of the mill. If a high gas temperature is set with the burner 17, a small amount of gas is needed in the circulation, and the gas stream 12a is omitted (i.e. 100% to the spray tower 6). On the other hand, if no burner 17 is provided when drying alternative fuels, and only a low temperature (for example 200° C.) is reached in the heat exchanger 15, most of the gas is recirculated through the line 12a, and only a small portion, for example 15%, is dried in the spray tower 6. Advantage: No CO₂ from combustion and little CO₂ in 9, and therefore activated charcoal can be used, for example, to remove toxins such as chlorinated hydrocarbons.

The condensate formed in the spray tower is likewise circulated, for the most part, specifically by way of a cooling heat exchanger 7; a substream of the condensate, formed from the excess, is removed from the system by way of a line 8.

At this point it should be pointed out that the heat exchanger 7 can be configured as an integral component of the spray tower 6. A portion of the transport/drying gas stream cooled in the spray tower 6 can be removed from the system by way of the line 9 and, optionally, by way of a blower 21, and for example, as shown, purified by a gas purifier 10, for example an adsorbent, and discharged to the environment, or passed to a furnace in order to burn off the toxins it still contains. The significant portion is passed back into the circulation system by way of the line 13, for further drying.

The substream circulated by way of a heating heat exchanger 11 in the line 12a, and the substream 13 cooled by the spray tower, are combined and delivered, by way of the line 14, to another heat exchanger 15 used for heating. The total gas stream is then fed, by way of the line 22, over a burner 17, in order to increase its temperature, and from there it is fed, in heated form, into the mill 2. The fuel and oxygen feeds assigned to the burner 17 are labeled 18 and 19, while the arrow 20 indicates an inert gas feed to the mill 2.

As can also be seen from the system circuit, the heat exchanger 15 can be circumvented by way of a bypass 16, particularly in order to regulate the temperature of the total circulated gas volume, whereby this bypass 16 can also be an integral structural part of the heat exchanger 15.

The mode of operation of the present invention is described below, using an example.

The supplied coal 1, for example 50 kg/s, is to be dried from 30 wt. -% to 3 wt. -%. 14 kg/s of moisture must be evaporated, for which 36 MW are needed. After considering other heat sinks and the supplied grinding energy, the heat demand is about 40 MW. The temperature of the circulated gas is 460° C. before reaching the mill 2, and 105° C. thereafter. At the specific heat capacity of the gas of 40 kJ/kmol/K, 2.8 kmol/s are necessary at the input to the mill 2 to cover the heat demand. 36 kg/s of dried coal are deposited in the filter 3. 80% of the gas cleaned of dust in the filter 3 are passed to the spray tower 6.

Upon cooling to 45° C., the moisture in the gas is reduced from 35 vol. -% to 10 vol. -%, and 14 kg/s of water condense out. To purify the gas 10 and release it into the atmosphere, 0.09 kmol/s (2.5 m³/s) of the demoisturized gas is split off. The gas flowing through the heat exchanger 11 is heated to 180° C. The temperature of the mixture (line 14) is 80° C., and the dew point is 60° C., so that the water droplets entrained from the spray tower 6 evaporate ahead of the heat exchanger 15. The gas is heated to 234° C. in this heat exchanger 15. The burner 17 is provided with a gas mixture of CO:H₂=1:1 and with oxygen (95% O₂) (arrows 18, 19). To reach the waste gas temperature of 460° C., 25 MW (Hu) are consumed.

In addition to the system circuits described above, alternatives can also be provided according to the invention, including the following:
as above, but without fuel burner 17, for practical purposes with little evaporation in the mill and with purification 10 using activated charcoal, which is deactivated by CO₂ from combustion,
as above, but without heating 11 of the spray tower bypass stream, for practical purposes at 12 >13, i.e. with little evaporation in the mill,
without 11, 15, 16—lower investment costs, but more release into the atmosphere 9, 10; greater, higher fuel consumption 18, but no steam necessary,
cooler 8 integrated into the spray tower 6,
cooling tower in the form of a heat exchanger whose surface is sprayed/wetted with circulating condensate,
a condensate separator with droplet separator follows the spray tower,
blower 21 instead of increasing the pressure level of the gas circulation,
water injection instead of bypass 16,
water circulation by way of an external cooling tower, for example power plant cooling tower, instead of cooler 7,
heat from the heat exchanger 7 is utilized, for example to heat the cold water,
the wastewater treatment depends on the wastewater composition, for example biologically or by oxidation, directly in a cooling tower, or passed to a water treatment plant,
multiple successive spray towers to better separate out particles contained in the gas 12 in low concentrations, and to avoid deposits in the heat exchanger 15.

1. Method for drying fuels in the form of dust, especially fuels to be fed to a gasification process, such as coal, petroleum coke, biological wastes, or the like, whereby the fuel is crushed in a mill and passed to a filter/separator by means of a transport and drying gas, and at least a portion of the transport/drying gas in circulation is passed back into the mill after heating, wherein
the temperature of the transport/drying gas stream is raised by a burner before entry into the mill and
a portion of the transport/drying gas stream is cooled and demoisturized in a spray tower or the like, whereby a portion of the dried gas leaving the spray tower is passed into the surroundings and/or to a furnace, and the other portion is passed back into the transport/drying gas stream.

2. Method according to claim 1, wherein
the gas stream taken out of the system is subjected to adsorption (hydrocarbons other than CH₄, CO₂), (catalytic) combustion, or catalytic conversion (NOₓ, chlorinated hydrocarbons).

3. Method according to claim 1, wherein
the transport/drying gas stream, after the dried gas substream from the spray tower cooler is mixed in, is passed to a heat exchanger.

4. Method according to claim 3, wherein
to control the temperature of the transport/drying gas stream, at least a substream can be conducted around the circulation heat exchanger, by way of a bypass.

5. Method according to claim 1, wherein
a substream of the condensate formed in the spray tower is circulated by way of a cooling heat exchanger.

6. Method according to claim 1, wherein
the temperature of the gas stream is matched to the temperature of the recirculated gas stream leaving the spray tower, by way of another heat exchanger provided in the main circulation of the transport/drying gas stream.

7. Method according to claim 1, wherein
a purification and/or pressure-raising device is provided for the stream of gas for release to the environment or to a furnace.

8. (canceled)

9. Method according to claim 1, wherein
an inert gas such as N₂, noble gases, CO₂, or the like, are fed into the circulation, especially when the circulation is started up.

10. Method according claim 1, wherein
at least 15% of the gas stream (21) from the mill is passed to the dryer, for example by way of the spray tower.

11. Device for drying fuels in the form of dust such as coal, petroleum coke, biological wastes, or the like, having a fuel-crushing mill (2), a transport/drying gas line (21) to a solids separator (3), and a return line (22) to the fuel mill (2) for the transport/drying gas stream, in particular to implement the method according to claim 1, further comprising
a transport/drying gas bypass line (12) having a gas cooler (6), as well as a heating burner (17) provided in the transport/drying gas stream, ahead of the mill (2).

12. Device according to claim 11, wherein
the gas cooler is configured as a spray tower (6).

13. Device according to claim 12, wherein
the spray tower condensate is circulated, at least in part, whereby a heat exchanger (7) is provided in the condensate circulation, for cooling the condensate.

14. Device according to claim 13, further comprising
a transport/drying gas return line (13) for a portion of the gas from the spray tower (6) into the transport/drying gas circulation line (14, 22) to the mill (2), and a line (9) to transport a substream out of the system, in particular to a purification or combustion stage (10).

15. Device according to claim 14, further comprising
at least one heat exchanger (11, 15) that serves to heat the transport/drying gas stream.

16. Device according to claim 11, wherein
a heat exchanger (11) serving as a heater is provided ahead of where the circulated transport/drying gas stream is combined with the gas stream leaving the spray tower (6), and a heat exchanger (15) is provided after where they are combined.

17. Device according to claim 11, wherein
the heat exchanger (15) for heating the total transport/drying gas stream is provided with a bypass (16) for at least a substream, for temperature regulation.

18. Device according to claim 11, wherein
a pressure-raising blower (21) is provided in the waste gas line (9) leading out of the system.

19. (canceled)

20. Device according to claim 11, wherein
an inert gas feed (20) is provided in the region of the mill (2).

21. Device according to claim 17, wherein
the bypass (16) is integrated into the heat exchanger (15).

22. Device according to claim 13, wherein
the cooler/heat exchanger (7) for the condensate is integrated into the spray tower (6).
